(19) United States
(12) Patent Application Publication
(10) Pub. No.: US 2004/0103979 A1
(43) Pub. Date: Jun. 3, 2004

(54) Method of making a composite web

(75) Inventor: Walter Kramer, Bonn (DE)

Correspondence Address: THE FIRM OF KARL F ROSS, 5676 RIVERDALE AVENUE, PO BOX 900, RIVERDALE (BRONX), NY, 10471-0900, US

(73) Assignee: Reifenhauser GmbH & Co. Maschinenfabrik

(21) Appl. No.: 10/660,373

(22) Filed: Sep. 11, 2003

(30) Foreign Application Priority Data
Oct. 17, 2002 (EP) 02023278.1

(51) Int. Cl. B32B 7/14; B32B 31/08

(52) U.S. Cl. 156/167; 156/291

(57) ABSTRACT

A composite is first formed by depositing on a breathable but water-impermeable synthetic resin film, a multiplicity of molten binding polymer threads from a multiplicity of orifices so that there is substantial space between the threads. A second web, e.g. an open-pore structure is then bonded to the first web by the molten thread so that the composite retains the flexibility and softness of the open-pore structure and the breathability of the film.

### FIELD OF THE INVENTION

My present invention relates to a method of making a composite web with at last one open pore web structure and at least one layer formed as a foil. The invention also relates to a method of making a composite web from a mat or fleece, hereinafter referred to as a nonwoven web, and a synthetic resin foil web.

### BACKGROUND OF THE INVENTION

Various methods for producing composite webs having a foil and a mat or nonwoven structure are known in the art. For example, a nonwoven mat or fleece can be bonded to a synthetic resin foil which is “breathable” to allow at least limited passage of gasses but is water impermeable and is thus a so-called membrane foil.

The bond between these two materials, i.e. the foil and the nonwoven mat can be effected, for example, by ultrasonic welding. The bond can also be achieved with the aid of an adhesive which can be applied over the surface or interface of the two materials, e.g. by being applied to one or another of the webs. Upon application of the adhesive to one of the webs, the web carrying the adhesive may be applied and cemented to the other. In this case, the adhesive is disposed between the two webs. This method has a drawback in that the adhesive can interfere with the breathability of the foil web.

In addition with this type of bonding, there is frequently undesirable hardening and sealing in the bonding region and thus a negative effect on the softness of the composite or the nonwoven or fleece structure.

Composites made by the conventional processes are usually difficult to recycle as well. As a result, such composites may become environmental problems.

### OBJECTS OF THE INVENTION

It is, therefore, the principal object of the present invention to provide an improved method of making a composite, especially a composite web comprising a nonwoven web and a film or foil whereby the aforedescribed drawbacks are avoided and the desirable characteristics of both the nonwoven web or fleece and the foil or film are retained in the composite.

Another object is to provide a method of making a composite web in which the composite web is not negatively affected by the bonding between the nonwoven or fleece structure and the foil or film.

### SUMMARY OF THE INVENTION

These objects and others which will become apparent hereinafter are attained, in accordance with the invention, in a method of making a composite, especially a composite web from at least one open-pore web and at least one film web, usually of a breathable but water-impermeable synthetic resin foil or film whereby upon a first of these webs, from a multiplicity of nozzle orifices molten binding polymer is injected in a thread configuration so that between the bonding polymer threads, regions free from the binding polymer remain on the first web, and the second web is applied to the molten binding polymer on the first web to bond the two webs together with the binding polymer threads.

The two webs can be comprised advantageously of a synthetic resin. The expression “binding polymer” or “bonding polymer” is intended to mean in the sense of the invention a polymer which in its molten state can bond to the two webs of the composite. To produce the threads of molten polymer, preferably a multiplicity of nozzle orifices are provided above the first web. That multiplicity of nozzle orifices can be formed by a multiplicity of nozzles connected in parallel.

By comparison with conventional techniques which apply an adhesive over the entire area of one or both of the webs, the invention applies the molten binding polymer in the form of threads or films leaving regions between them on the webs and in the composite in which there is no binding polymer or no binding polymer threads.

Preferably the method is carried out so that at least 30% of the area and even more preferably at least 40% of the area of the first web remains free from binding polymer threads.

Surprisingly the method of the invention provides a faster bonding of the two webs together via the thread than can be achieved with adhesives.

While preferably the open-pore web is a nonwoven fleece, it can also be a woven or textile web.

According to a feature of the invention, one or more nonwoven or fleece layers and/or one or more woven or textile layers can constitute the open-pore web. The nonwoven web can be constituted from filaments and/or fibers of thermoplastic synthetic resin. The term “filament” is used here to refer to theoretically unending synthetic resin threads, generally individual continuous synthetic resin threads, while the term “fibers” is used here to refer to shorter lengths of such threads. The individual filaments and threads may be bonded together at crossover locations and wherever they may contact one another to form the mat. A typical nonwoven mat of this type may be, for example, a spun-bond web.

In the case of fibers, they too may be synthetic resin elements which, for example, can be produced by the melt-blown technique to form a melt-blown fleece or mat. These fibers as well are normally arranged together at crossover and contact regions.

The foil or film web can be a synthetic resin film, as noted, and preferably is film capable of breathing in the sense previously described and may be a breathing-intensive or breathing-active film, which however, is water impermeable. A suitable synthetic resin film for the purposes of the invention and a preferred film is composed of at least one polyolefin.

According to the invention, the composite consists of two webs with the intervening bonding threads of the binding polymer forming a fixed bond between the two webs.

When reference is made here to a thread-like shape of the molten polymer which is deposited on the first web, a filament, thread or fiber configuration is intended. The binding polymer should, of course, be molten as applied to the first web and at least until after the second web has been applied.

The threads of the molten polymer can have individual thread thicknesses of 10 to 50 μm, preferably 10 to 40 μm and most advantageously 10 to 30 μm. The thread thicknesses here is the diameter of the molten polymer strand at least as it is applied to the first web. The strand should remain molten until the second web is applied and can bond to it by hardening of the strand.

It has been found to be advantageous to apply the binding polymer in the form of a wave pattern of the threads and this can be achieved by causing the molten polymer to emerge from the nozzles in a wave pattern. The polymer threads thus do not have a linear pattern as they are applied to the first web but rather are laid down in a wave pattern with crests and troughs. The threads can have a varying wave configuration with varying amplitude and frequency of the wave pattern and a wave pattern which can be symmetrical or asymmetrical. For example, the binding polymer thread can be deposited in a wave pattern of omega-shaped waves.

U.S. Pat. Nos. 5,882,573, 5,902,540 and 5,904,298 disclose the use of nozzles for dispensing adhesives in wave patterns. The wave form can be influenced as well by the flow characteristics of the product and the nozzle openings. Such systems can be used for depositing the binding threads of molten polymer for the present invention.

It has been found to be advantageous to flank the nozzle orifice from which a thread of molten polymer is dispensed by two nozzle openings from which respective air streams emerge on opposite sides of the orifice and training the respective air jets on the emerging molten synthetic resin strand. The wave form and oscillation parameters of the strand-like amplitude and frequency can thus be defined by the variations in one of the air streams relative to the other and/or from the volume rates of flow of air from the respective jets and/or by the relative velocity of the flows from the jet nozzle, all with respect to binding polymer flow.

In addition this arrangement allows oscillation parameters, especially amplitude and frequency to determine the relative spacing of the thread. The spacing will also be determined by the shape and opening widths of the nozzle orifices, angles of the nozzle or nozzle orifices relative to one another and the air jet controls.

The molten polymer can be deposited with at least one melt-blown nozzle, in which case the bonding polymer, initially extruded from an extruder is fed in the molten state through a melt-blown nozzle which is associated with air jets. That means that the extruded molten binding polymer emerges from its nozzle orifice interacting with the air jets as in a melt-blown nozzle.

Preferably the first web is composed of a polyolefin and/or the web later applied to the molten threads, i.e. the second web, is composed of a polyolefin. Both webs may be composed of polyolefins and the same polyolefin or different polyolefins. When the two webs are composed of the same polyolefin, the polyolefin is preferably polyethylene.

In a preferred embodiment, moreover, the binding polymer is composed of the same material as the first web and/or as the second web, for example, the same polyolefin such as polyethylene or polypropylene. The resulting material, where it consists of polymers, especially polyolefins, is easily recyclable.

It is important to the invention that the binding polymer does not completely cover the first web or cover major portions of the area of the first web but rather is present only in the form of individual threads leaving binding polymer-free regions free between the threads. It has been found to be advantageous to apply the binding polymer in an amount of 0.75 to g/m² of the first web, preferably 1 to 4 g/m² and most advantageously 1.5 to 3 g/m².

The invention permits the two webs of the composite to be combined and arranged to one another in a fixed manner without the negative characteristics of the earlier techniques which have been described. Thus the breathability of the film is not adversely affected and the softness of the open-pore material remains. The composite is relatively inexpensive, easily recycled and can be used for hygienic products such as diapers, sanitary garments and the like or even in the field of building materials.

### BRIEF DESCRIPTION OF THE DRAWING

The above and other objects, features, and advantages will become more readily apparent from the following description, reference being made to the accompanying drawing in which:

FIG. 1 is a perspective view of an apparatus for carrying out the method of the invention;

FIG. 2 is a diagram showing an arrangement of a nozzle orifice for the binding plastic thread and two air jets flanking same to form an undulating thread pattern;

FIG. 3 is a plan view of a first web onto which the binding polymer threads are extruded in accordance with the invention;

FIG. 4 is a plan view of another binding polymer thread pattern which can be used in accordance with the invention;

FIG. 5 is a cross sectional view through a composite in accordance with the invention, the thicknesses being greatly exaggerated; and

FIG. 6 is a cross sectional view similar to FIG. 5 of another embodiment of the invention.

### SPECIFIC DESCRIPTION

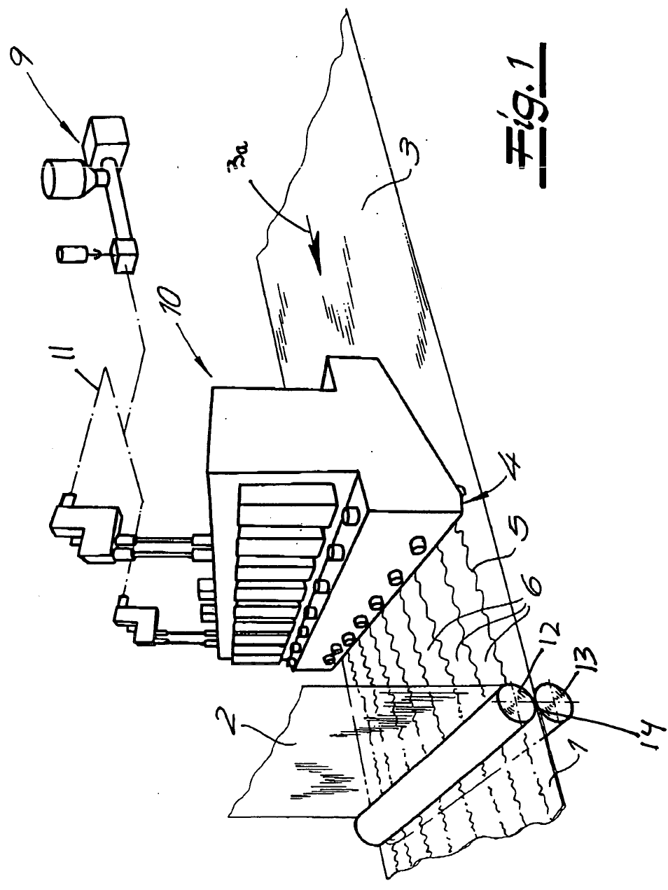

In FIGS. 1 and 2 there is shown a device for producing a composite by the method of the invention and in which the composite is represented at 1 and comprises an open-pore web 2 and a plastic film 3. More particularly, the open-pore web 2 can be a fleece or melt-blown technology while the film 3 is a synthetic resin film which is breathable but water impermeable.

The film 3 is advanced, e.g. from a roll or a film-blowing apparatus not shown in detail, in the direction 3a past a nozzle head 10 which communicates with an extruder 9 for producing a molten polyolefin (polyethylene, polypropylene or a mixture of polyethylene or polypropylene). The molten synthetic resin is delivered at 11 to the nozzle head 10 and is maintained in a molten state within the head by heaters (not shown). The nozzle head has a multiplicity of nozzle orifices 4, each of which dispenses a bonding polymer strand 5 in the shape of a thread and hereinafter referred to as a bonding polymer thread. The binding polymer threads 5, in a molten state, are deposited upon the film 3 constituting a first web. As shown, large areas 6 between the binding polymer threads 5 are free from the binding polymer. The binding polymer 5 in its molten and hot state, fuses with the synthetic resin of the film 3.

The second web 2, e.g. of the nonwoven fiber or filament type, is applied to the binding polymer threads 5 downstream of the head 10 between two rollers 12, 13 by passing the sandwich of the two webs and the molten polymer threads 5 through the nip 14 of the rolls. The second web 2 is thus bonded to the molten polymer which can harden to bind the webs together and produce the composite 1.

The threads 5 are deposited in a wavy configuration as can be seen from FIG. 1 and the wave form can be symmetrical or unsymmetrical.

To produce the wave pattern, each orifice 4 may be flanked by air jets 8 from nozzles 7. By varying the air streams from the nozzles 7, the wave form can be varied. Reference may be mad to U.S. Pat. No. 5,902,540 in this regard.

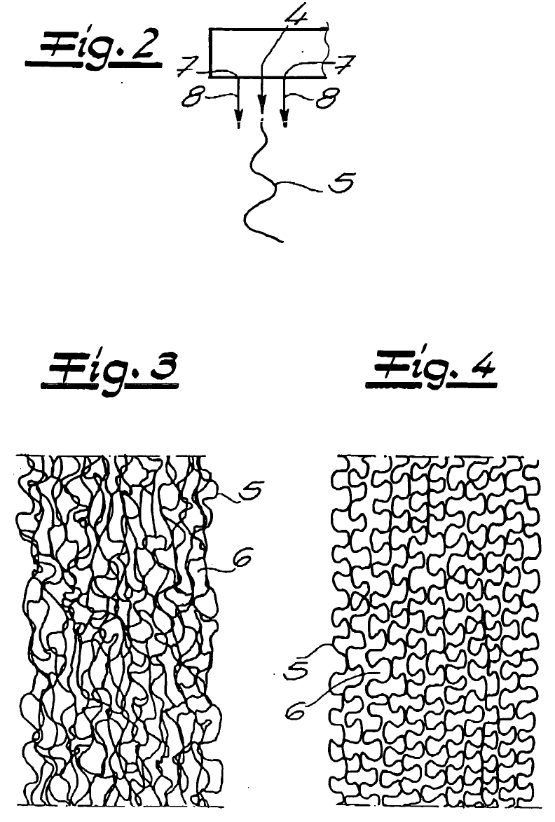

In FIG. 3 the pattern of another first web has been shown which is in the form of a nonwoven filamentary web onto which binding polymer threads 5 have been deposited in an irregular wavy pattern 1 with spaces between them as shown at 6.

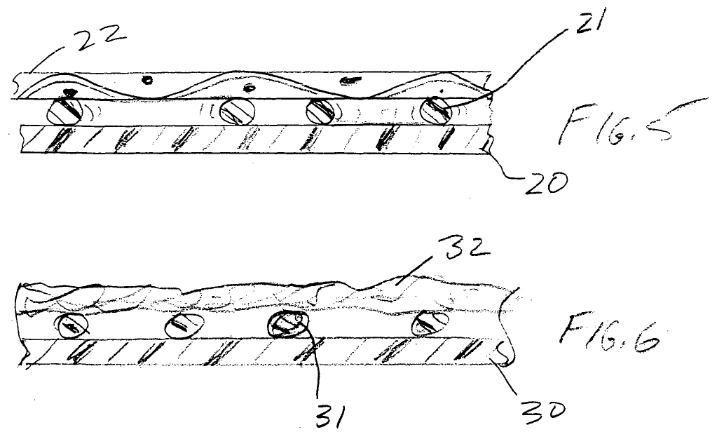

In FIG. 4 the threads 5 are shown to be deposited in an omega wave pattern of the first web and the gaps between the omega webs are represented at 6. In FIG. 5, the plastic film has been shown at 20, the binding threads at 21 and the openwork or open-pore web at 22, the latter being a textile fabric. In the embodiment of FIG. 6 the composite is formed by the breathable film 30, the threads 41 and the melt-blown or spun-bond fleece 32. In both the embodiment of FIG. 5 and the embodiment of FIG. 6 all of the material can be either polyethylene or polypropylene.

I claim:

1. A method of making a composite web comprising the steps of:
(a) applying to a first web from a multiplicity of nozzle orifices a multiplicity of thread-shaped strands of a molten bonding polymer and bonding said strands to said first web in a pattern leaving bonding-polymer-free regions on said first web; and
(b) applying a second web to the strands of molten bonding polymer and bonding said second web to said strands, one of said first and second webs being a foil and the other of said first and second webs having an open-pore structure.

2. The method defined in claim 1 wherein said other web is formed as a nonwoven fleece or a textile.

3. The method defined in claim 2 wherein said foil is formed as a synthetic resin foil web.

4. The method defined in claim 3 said first web is formed as a synthetic resin foil web and said second web is formed as a nonwoven fleece or a textile.

5. The method defined in claim 4 wherein said molten bonding polymer is deposited on said first web in thread-shaped strands of a thickness of 10 to 50 μm.

6. The method defined in claim 5 wherein said thickness is maintained at 10 to 40 μm.

7. The method defined in claim 6 wherein said thickness is maintained at 10 to 30 μm.

8. The method defined in claim 5 wherein the bonding polymer is deposited on said first web in the form of bonding polymer threads in a wave pattern.

9. The method defined in claim 5 wherein the bonding polymer is deposited on said first web by at least one melt-blown nozzle.

10. The method defined in claim 5 wherein at least one of said webs is formed from a polyolefin.

11. The method defined in claim 5 wherein the bonding polymer is applied to said first web in an amount of 0.75 to 5 g/m².

12. The method defined in claim 5 wherein the bonding polymer is applied to said first web in an amount of 1 to 4 g/m².

13. The method defined in claim 1 wherein said foil is formed as a synthetic resin foil web.

14. The method defined in claim 1 said first web is formed as a synthetic resin foil web and said second web is formed as a nonwoven fleece or a textile.

15. The method defined in claim 1 wherein said molten bonding polymer is deposited on said first web in thread-shaped strands of a thickness of 10 to 50 μm.

16. The method defined in claim 15 wherein said thickness is maintained at 10 to 40 μm.

17. The method defined in claim 16 wherein said thickness is maintained at 10 to 30 Am.

18. The method defined in claim 1 wherein the bonding polymer is deposited on said first web in the form of bonding polymer threads in a wave pattern.

19. The method defined in claim 1 wherein the bonding polymer is deposited on said first web by at least one melt-blown nozzle.

20. The method defined in claim 1 wherein at least one of said webs is formed from a polyolefin.
